(19) United States
(12) Patent Application Publication
(10) Pub. No.: US 2002/0085797 A1
(43) Pub. Date: Jul. 4, 2002

(54) Optical fiber and switch assembly and method of making

(76) Inventor: Anthony Freakes, Leonia, NJ (US)

Correspondence Address: KAPLAN & GILMAN , L.L.P., 900NROUTE 9 NORTH, WOODBRIDGE, NJ, 07095, US

(21) Appl. No.: 10/003,599

(22) Filed: Nov. 26, 2001

Related U.S. Application Data
(60) Provisional application No. 60/253,115, filed on Nov. 27, 2000.

(51) Int. Cl. G02B 6/35; G02B 6/26

(52) U.S. Cl. 385/18

(57) ABSTRACT

The invention disclosed provides an optical switch and optical fiber assembly for the control of optical signals. The optical switch incorporates a mirror mounted on a resilient mirror platform. The mirror and the platform are movable between a first position and a second position. In the first position, the mirror reflects an optical signal emitting from an input optical fiber to a selected output optical fiber. In the second position, the mirror allows the optical signal to pass directly to a coaxially located output optical fiber. The input and output optical fibers are fixedly assembled to the switch. The switch and mirror platform are formed of crystalline silicon material, with the mirrors integral with the mirror platform.

### RELATED APPLICATION

This application derives priority in part from provisional patent application No. 60/253,115, filed Nov. 27, 2000.

### FIELD OF THE INVENTION

The present invention relates to the field of fiber optics and more particularly to the control of electromagnetic signal radiation.

### BACKGROUND OF THE INVENTION

The use of light as a carrier of information is increasing exponentially. The multiplicity of wavelengths available from the infra-red to the ultraviolet portion of the electromagnetic spectrum permits the transmission of a plurality of signals in a single fiber at the same time. Certain wavelengths, especially in the range of 1550 nanometers, have proven to be optimal for communication purposes. Fiber optic transmission is quickly replacing copper electric transmission in both short and long distance data and voice transmission.

Many devices and techniques have been developed to enhance the operational performance and advance the functionality of these optical communication systems. The continuing need to carry more signal traffic drives the telecommunication industry to attain constantly greater bandwidth capacity. Bandwidth essentially defines the divisions of wavelengths to optimize signaling capacity. Development of Wavelength Division Multiplexing (WDM) and Dense Wavelength Division Multiplexing (DWDM) are two significant examples of advances in this field.

Whenever the light signal must be changed, for example, switching it to a selected path, attenuate it, provide wavelength filtration, or otherwise work on the light beam, the light signal must exit the optical fiber and traverse through the ambient working space. The signal is reinserted into another fiber optic core at the completion of the modification process. Optical fibers are designed to retain the light signal within its core by creating an internally reflective barrier between the core and an outer coating known as cladding. Light naturally diverges once it exits the constraint of the fiber and it is useful to optically redirect it into a parallel beam. This redirection of diverging radiation is termed collimation. After working on, or steering the collimated beam as desired, the collimated beam is then focused so as to converge and enter the receiving optical fiber. Presently, there are several known devices for causing an optical signal to become collimated. A first such device is a Gradient Index (GRIN) lens in which the index of refraction varies as the diameter varies.

A variation of the GRIN lens is disclosed in U.S. Pat. No. 4,701,011 to Emkey et al., entitled Multimode Fiber-Lens Optical Coupler. This coupler is formed of a length of multimode optical fiber that is fused to the end of a single mode fiber of equal diameter to collimate a light signal. The coupler disclosed has a length equal to one quarter of the wavelength of the optical signal being transmitted.

A further variation of an optical lens is disclosed by Hirai et al. in U.S. Pat. No. 5,384,874 for an Optical Fiber Rod Lens Device And Method Of Making Same. The lens of the '874 patent is a gradient index lens that is not less in diameter than the single mode transmission fiber.

Shaped lenses are additional variations for use in conjunction with optical fibers in the manipulation of light. Shaped lenses are available in spherical or semi-spherical configurations. A particular lens employed in an embodiment of the present invention and in the shape of a sphere with a stem is made and supplied by Corning Incorporated of Corning, N.Y.

Such optical fibers with applied lenses are typically used to collimate emitted light for directional control while the signal is directed to a selected path by an optical switch. However, the optical switches using such designs are over 60 mm long. As in other technologies, large size is undesirable, since smaller devices operate faster and the distance over which a signal travels defines the time for transmission. Also, the assembly time for known optical switches is high and results in a cost level that will be under pressure as increased message traffic demands more cost effectiveness.

U.S. Pat. Nos. 5,436,986 and 5,642,446 to Tsai for Apparatus For Switching Optical Signals Among Optical Fibers (And Method) teach optical switch configurations. The Tsai switches are described as having mirrors for deflecting a light path from a straight transmission to a diverted transmission. The mirrors are moved in a plane that is parallel to the plane in which the two input and two output optical fibers reside, either by rectilinear or arcuate motion.

### SUMMARY OF THE INVENTION

The invention disclosed hereinbelow provides a switch for altering the path of an optical signal from an input optical fiber for transmitting via a selected output optical fiber. A length of multimode optical fiber is mounted as a lens to each input and output optical fiber. The fiber and lens assemblies are then mounted in a support channel formed on the optical switch with a gap left between the input and output lens ends. A mirror is interposed between the ends of the input and output lenses so as to be movable between a first position to intersect the light path and a second position out of the light path. The switch is substantially small and formed by etching a crystalline silicon chip.

### BRIEF DESCRIPTION OF THE DRAWINGS

The invention is described below with reference to the following drawings in which like features are identified with like numbers, and wherein:

FIG. 1 is an exploded perspective view of an optical fiber and fiber lens as used according to the present invention.

FIG. 2 is an enlarged perspective view of the optical fiber and fiber lens of FIG. 1 in assembled condition and showing an optical signal being transmitted therethrough.

FIG. 3 is a bottom plan view of a pair of input fibers and a pair of output fibers as shown in FIGS. 1 and 2 and mounted to a fiber locating chip.

FIG. 4 is a top plan view of a mirror chip with the input and output fibers superimposed thereon for descriptive purposes.

FIG. 4A is an enlarged view of the portion within the circle of FIG. 4 showing the mirrors in position and the optical signal paths between the ends of the input and output optical fibers.

FIG. 5 is a top plan view of the switch of the invention including the fiber locating chip of FIG. 3 with input and output fibers mounted thereto assembled and mounted to the mirror chip of FIG. 4.

FIG. 5A is a cross sectional view taken along line 5-5 of FIG. 5 and showing the assembled switch of the invention with the optical signal mirrors interposed between the ends of the input and output optical fibers.

FIG. 5B is a cross sectional view taken along line 5-5 of FIG. 5 and showing the assembled switch of the invention with the optical signal mirrors out of the line between the ends of the input and output optical fibers.

FIG. 5C is a cross sectional view taken along line 5-5 of FIG. 5 and showing the assembled switch of the invention with the optical signal mirrors interposed between the ends of the input and output optical fibers and a spring mounted therebelow.

FIG. 6 is a perspective schematic diagram of a second embodiment of the invention with a pair of input optical fibers and a pair of output optical fibers bearing spherical optical lenses and the two mirrors mounted on individual mirror platforms.

FIG. 7 is a top plan view of a mirror chip according to a third embodiment of the invention with the input and output fibers superimposed thereon for descriptive purposes.

FIG. 7A is an enlarged view of the portion within the circle of FIG. 7 showing the mirrors in position and the optical signal paths between the ends of the input and output optical fibers.

### DETAILED DESCRIPTION OF THE INVENTION

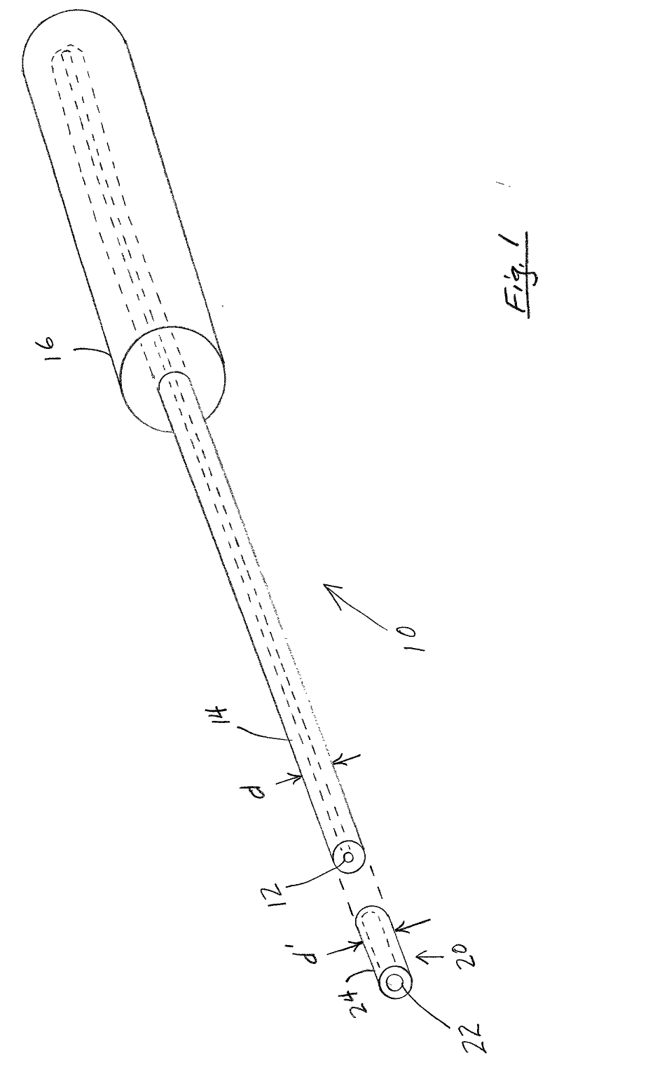

Referring now to FIG. 1, an optical fiber 10 according to the invention is illustrated in perspective view with an optical lens 20 positioned for assembly thereto. Optical fiber 10 comprises core 12, on which cladding 14 is coated, and which is contained in coating 16. As is known in the art, core 12, preferably a single mode fiber, carries optical signals along its length, the optical signals being reflected inwardly by the addition of cladding 14 having a different index of refraction than core 12. Coating 16 is coated onto cladding 14 to improve the fiber's handling characteristics and resistance to damage. For mounting to an optical switch or for splicing the fiber together, coating 16 is removed from a selected length of cladding 14.

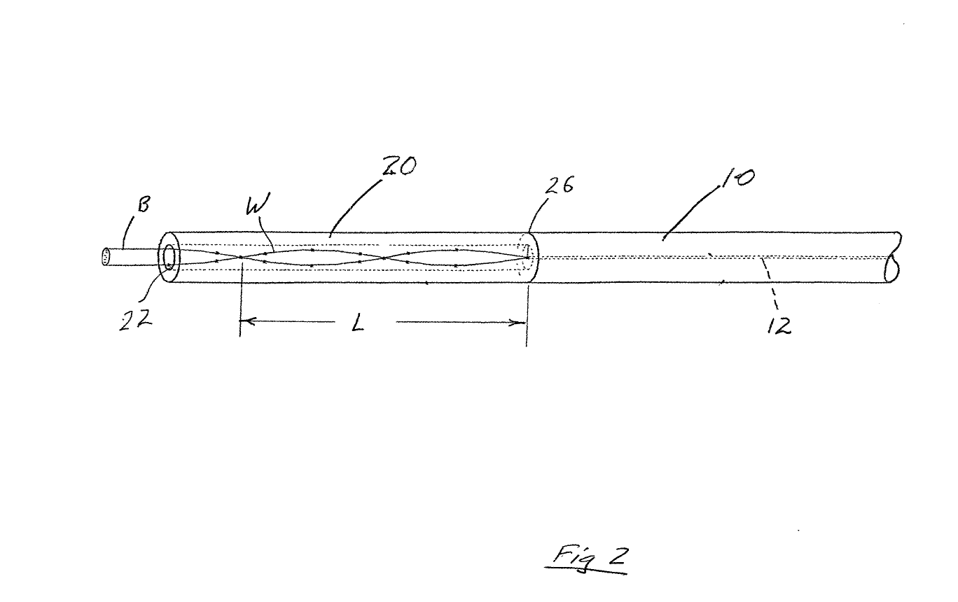

A piece of multimode optical fiber is provided as optical lens 20. Optical lens 20 comprises core 22 and cladding 24. According to the preferred embodiment, the diameter d of optical fiber 10 and diameter d′ of optical lens 20 are substantially equal to one another. Referring now to FIG. 2, optical lens 20 is shown assembled to optical fiber 10 at interface 26 by any method known in the art, wherein core 12 of optical fiber 10 and core 22 of optical lens 20 are coaxial and contiguous. A preferred method for assembly of lens 20 to fiber 10 is known as fusing, accomplished by heating one or both ends before placing them in contact. The optical signal exits from optical fiber 10 and enters optical lens 20 at interface 26. Whereas core 22 of optical lens 20 is of a larger diameter than core 12 of optical fiber 10, and core 22 is formed of multimode optical fiber, the optical signal undulates sinusoidally along its length, in waveform W. One full sinusoidal wave of waveform W has a length L. The invention recognizes that the projection of the optical signal at the peak of waveform W is substantially parallel to the axis of core 20 and that the waveform peak occurs at the first and third quarter cycle. Thus, by cleaving optical lens 20 at a length equal to any odd multiple of a quarter of the waveform cycle, the light will emit in a parallel beam. The invention further recognizes that although the beam is initially parallel, light naturally diverges over distance. Therefore, once the light beam has emerged from the controlled confinement of an optical fiber, in order to retain the maximum signal strength, the distance of free air exposure is preferably minimized. In the illustration of FIG. 2, optical lens 20 is cleaved at 1.25 sine cycles (1.25×L), resulting in beam B emerging from optical lens 20 as a Gaussian light bundle, i.e. substantially parallel as emitting from and entering respective optical fibers and slightly more compact at the mid-point therebetween.

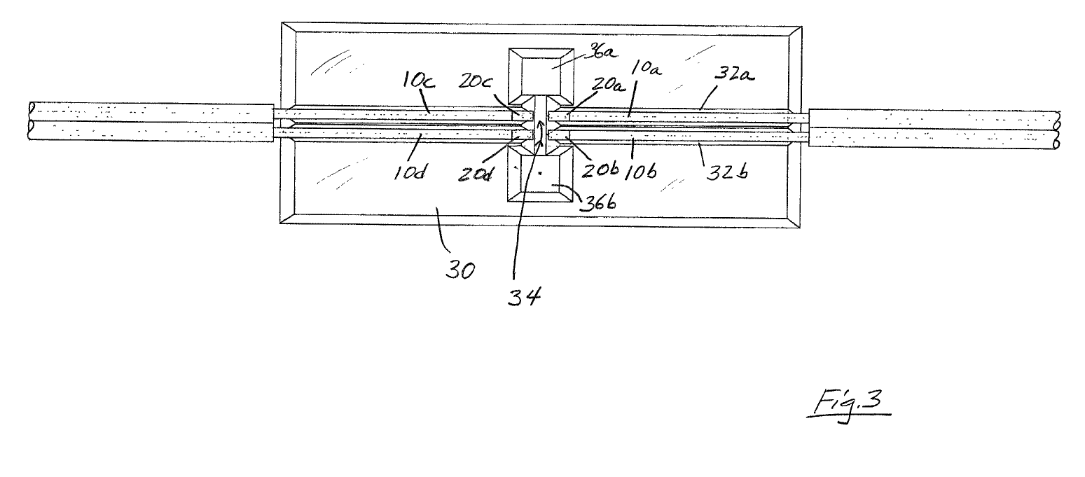

Referring now to FIG. 3, a fiber locating chip 30 is shown in bottom plan view. When assembled as is described below, fiber locating chip 30 will be inverted from the orientation shown. Chip 30 is formed substantially planar with a pair of parallel, rectilinear, channels 32a and 32b formed as guiding means across the visible surface thereof. Channels 32a and 32b are formed to securely nest an end portion of optical fibers 10a, 10b, 10c and 10d from which the coating has been stripped. Optical lenses 20a-20d have been assembled to the end of each optical fiber 10a-10d as described above. In the preferred embodiment of the invention, channels 32a and 32b are “V” shaped so as to accurately support input optical fibers, e.g. 10a and 10b coaxially with output optical fibers 10c and 110d. A gap 34 is provided between the ends of optical lenses 20a and 20c and between the ends of optical fibers 20b and 20d. In this orientation, an optical signal being transmitted along the length of optical fiber 10a will enter optical fiber 10c and an an optical signal being transmitted along the length of optical fiber 10b will enter optical fiber 10d. Chip 30 is further formed with a pair of windows 36a and 36b that are symmetrically located on either side of channels 32a and 32b and centered on gap 34.

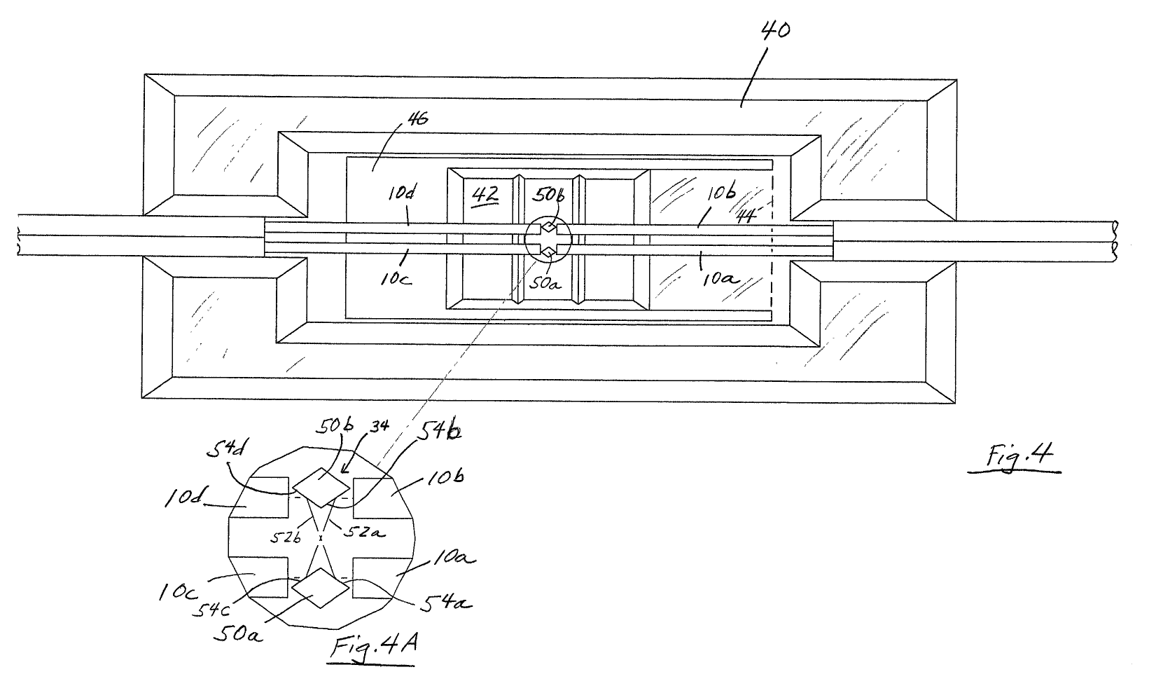

The illustration of FIG. 4 shows mirror chip 40 with optical fibers 10a-10d superimposed thereon for purposes of description. Mirror chip 40 is substantially planar. A mirror platform 42 is formed integrally with mirror chip 40 and connected thereto at flex line 44 in a configuration for enhancing the resiliency thereof. The other three edges of mirror platform 42 is surrounded by window 46. As will be described more fully below, when a force is applied to mirror platform 42, mirror platform 42 is deflected angularly out of the plane of mirror chip 40 along flex line 44. Mirror platform 42 returns to its initial position when force F is released. A pair of mirror blocks 50a and 50b are formed integrally on the surface of mirror platform 42 to be located between the ends of optical fibers 10a and 10c and optical fibers 10b and 10d, respectively. In the preferred embodiment, mirror blocks 50a and 50b are formed as a rhombus, with its opposed acute apexes parallel to the optical fiber axes.

FIG. 4A shows an enlarged view of the portion of FIG. 4 shown in a circle with mirror blocks 50a and 50b arranged to redirect optical signals to a diagonally opposed output optical fiber. The end of optical fiber 10a is shown opposed to the end of optical fiber 10c with mirror block 50a located in the intervening gap. Mirror block 50a is located so that the acute apexes of the rhombus are in a line parallel to and slightly offset from the axis of optical fibers 10a and 10c, and a light signal emitting from input optical fiber 10a hits the approximate center of mirror face 54a. The end of optical fiber 10b is shown opposed to the end of optical fiber 10d with mirror block 50b located in the intervening gap. Similarly, mirror block 50b is located so that a light signal emitting from input optical fiber 10b hits the approximate center of mirror block 50a. Mirror faces 54a and 54c of mirror block 50a and mirror faces 54b and 54d on mirror block 50b are coated with a highly reflective material, preferably gold. In this arrangement, when mirror block 50a is positioned between optical fibers 10a and 10c, and mirror block 50b is positioned between optical fibers 10b and 10d, a first optical signal travels in the form of electromagnetic energy along light path 52a from input fiber 10b to reflect off mirror faces 54b and 54c to enter output fiber 10c as a second optical signal travels along light path 52b from input fiber 10a to reflect off mirror faces 54a and 54d to enter output fiber 10d. This optical signal manipulation effectively re-routes the optical signals to alternate output optical fiber paths. When mirror blocks 50a and 50b are not in the path of the light signals, a light signal exiting from input optical fiber 10a transmits directly to output fiber 11c and a light signal exiting from input optical fiber 10b transmits directly to output optical fiber 10d.

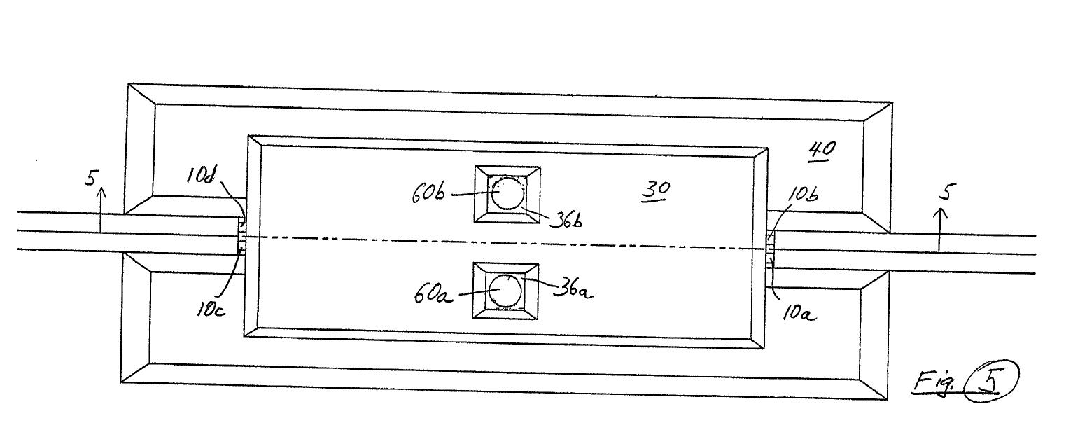

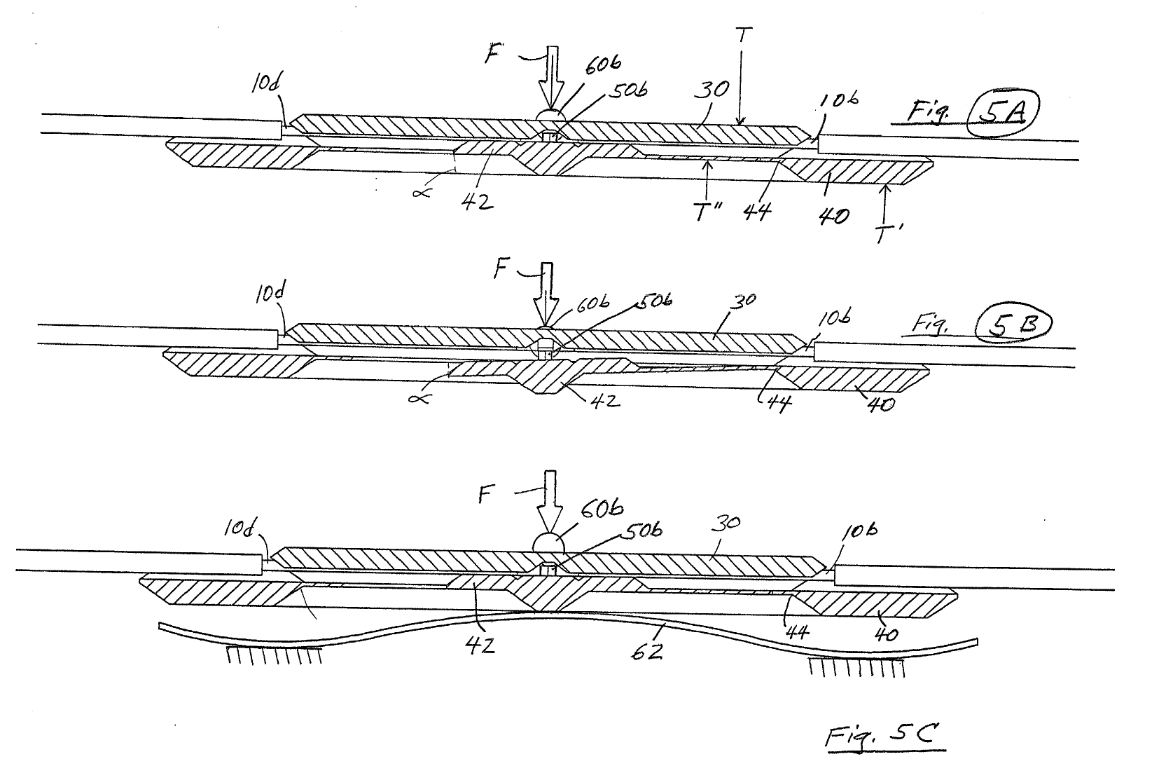

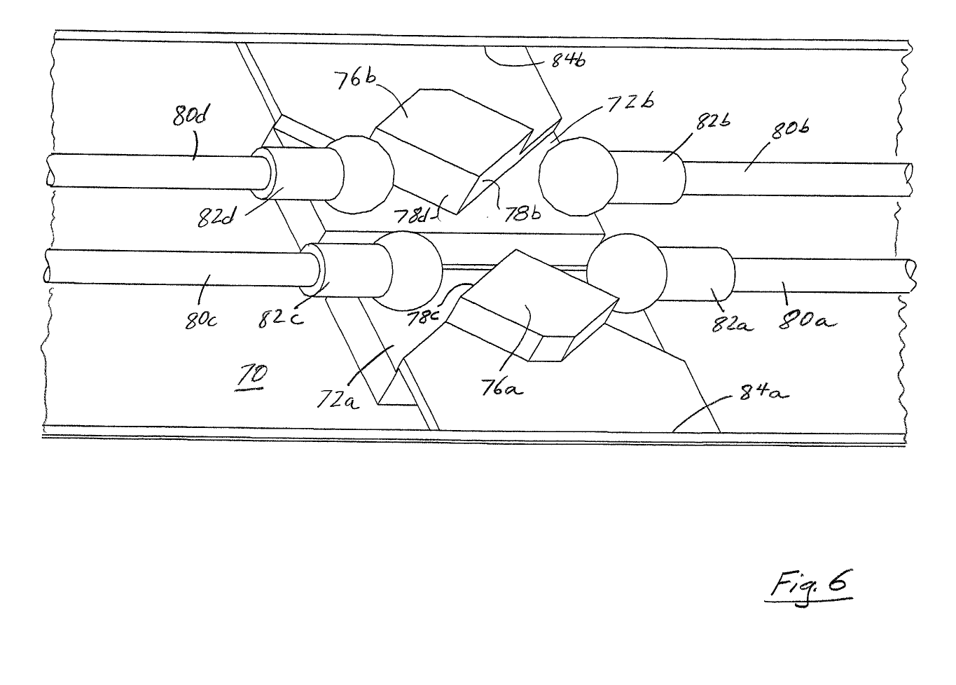

Referring now to FIG. 5, the optical fiber and switch assembly of the invention is shown in top plan view with fiber locating chip 30 having optical fibers 10a-10d mounted thereon and fiber locating chip 30 being mounted upon mirror chip 40. FIGS. 5A and 5B show a side view cross section of the assembly, clearly portraying the nesting of the beveled outer edge of fiber locating chip 30 into the beveled inner edge of window 46 (see FIG. 4) of mirror chip 40. The mounting of the named components one to another is accomplished preferably by use of an adhesive, most preferably by use of an epoxy adhesive. As is known in the art, epoxy adhesives provide durable adhesion that resist heat and chemical degradation.

A force transfer member, for example balls 60a and 60b, are positioned in each window 36a and 36b, respectively. Balls 60a and 60b are of a diameter that is able to move freely through windows 36a and 36b, respectively. Balls 60a and 60b are preferably formed of a substantially rigid material so as to transmit forces efficiently. Balls 60a and 60b may be glass balls, which are readily available and substantially inelastic.

Referring now to FIGS. 5A, 5B and 5C, the operation of the invention is depicted. Arrow F illustrates the direction of a force to be applied and ball 60b resides within window 36b and extends upwardly above the upper surface of fiber locating chip 30. FIG. 5B illustrates the arrow F representing a force having been applied to ball 60b, with ball 60b repositioned downward into window 36b and only a small portion thereof seen above the upper surface of fiber locating chip 30.

In the relaxed condition shown in FIG. 5A, mirror block 50b remains in its normal position between input fibers 10a, 10b and output fibers 10c , 10d , reflecting the light signal into a new path. As seen in FIG. 5B, when ball 60b (and ball 60a, not seen in this view) is pressed down through window 36b on the surface of mirror platform 42 causing mirror platform 42 to deflect arcuately along line α about flex line 44 so as to pivot mirror block 50b downwardly. In the condition shown in FIG. 5B, mirror block 50b does not intersect the signal emitting from input optical fiber 10b and thus the light signal is transmitted in a straight line to output optical fiber 10d.

Referring now to FIG. 5C, a further biasing member, for example spring 62, is positioned so as to cause mirror platform 42 to be biased upwardly against the underside of fiber locating chip 30. Additional components portrayed in FIG. 5C are similar to the illustration and description of the optical switch in relation to FIG. 5A. While shown in the form of a leaf spring, spring 62 can be any form of resilient member. The addition of spring 42 provides greater security and speed of operation in moving mirror chip 42 from its downward position seen in FIG. 5B to position mirror block 50b between optical fibers 10b and 10d.

Fiber locating chip 30 and mirror chip 40 are each formed of crystalline silicon that has been chemically etched to create a desired shape. By virtue of the substrate material of the switch components being crystalline in nature, natural planes of demarcation exist. By selection of and etching to specific natural planes, a highly precise and repeatable shape can be created. In addition, the planes provide an extremely flat surface which can be coated to enhance its reflectivity. The choice of plane angle and location can be advantageously employed to produce the optical switch of the invention. In reference to FIG. 4A, the planes of mirror blocks 50a and 50b on which optical signal beams 52a and 52b impinge are preferably located so that signal beams 52a and 52b contact the approximate middle of the reflective surface. The distance between mirror block 50a and 50b is thus a function of the distance between the axes of optical fibers 10a, 10c and 10b, 10d. The reflective surfaces 54a-54d are each oriented at an angle of between 30° and 40° relative to the optical fiber axes, most preferably an angle of about 35°.

FIG. 6 illustrates one of many variations on the basic inventive concept represented in the present invention in perspective view of a mirror chip 70 with optical fibers 80a-80d superimposed thereupon. In practice, optical fibers 80a-80d are supported in channels on a mating fiber locating chip as described above in respect of the preferred embodiment of the invention. In a second embodiment of the invention, optical fibers 80a-80d each terminate in an assembly with respective spherical lenses 82a-82d. Other radially symmetrical lenses could be used. Spherical lenses 82a-82d and the like are available from Corning Incorporated of Corning, N.Y. Mirror chip 70 comprises a pair of identical and opposed segments, typical of which is mirror platform 72b on which mirror block 76b is formed. In its relaxed position, mirror platform 72b is substantially parallel to and planar with mirror platform 72a and rests in tangential contact against the surface of spherical lenses 82b and 82d. An optical signal emitting from lens 82b is thus reflected off mirror face 78b to mirror face 78c on mirror block 76a and to lens 82c. When mirror platform 72b is deflected substantially as described above with respect to the preferred embodiment, mirror platform 72b flexes about flex line 84b and mirror block 76b is displaced out of the path of a signal from lens 82b. In this situation, a signal from lens 82b is transmitted directly into lens 82d and optical fiber 80d. Flexure may be accomplished by forming mirror platforms 72a and 72b with a thin portion adjacent flex lines 84a and 84b, respectively, or by forming flex lines 84a and 84b as a torsion spring, configured to bias and control the orientation of mirror platforms 72a and 72b.

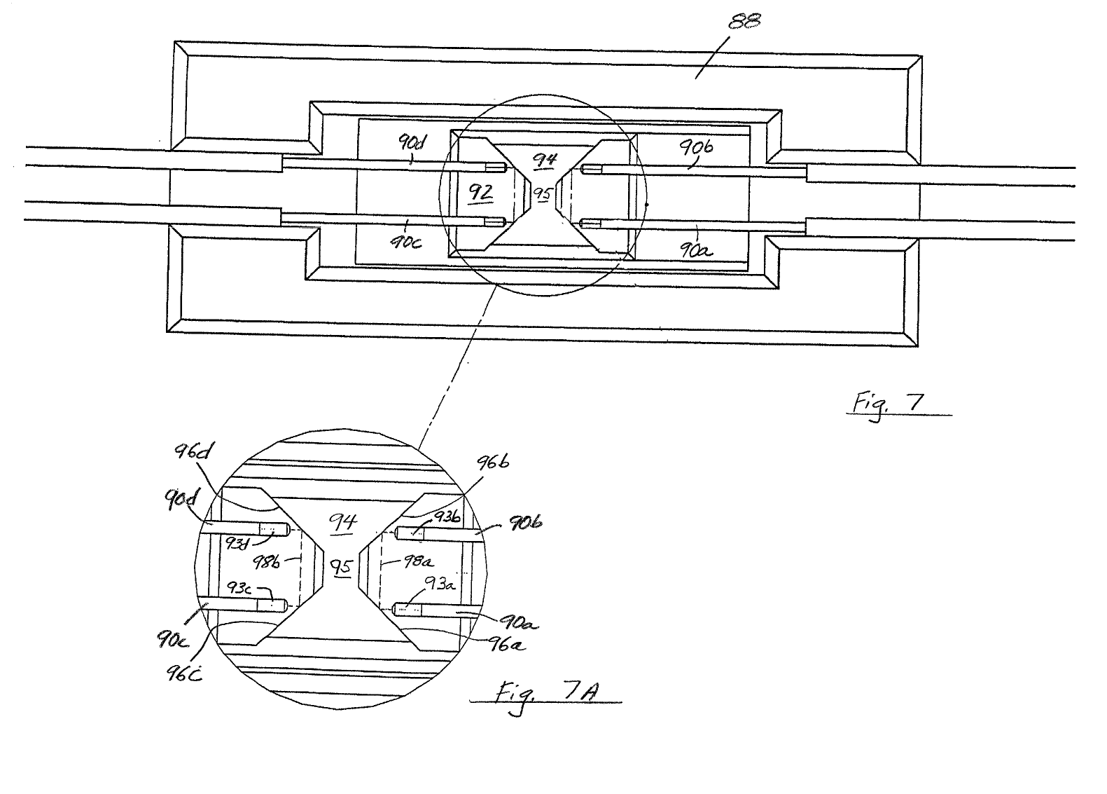

Referring now to FIGS. 7 and 7A, a third embodiment of the invention is illustrated. Optical fibers 90a, 90b, 90c and 90d are superimposed over mirror chip 88, with the optical fiber chip and optical fiber guide channels not shown here. Optical fibers 90a-90d are each faced with a form of spherical lens 93a-93d. Spherical lens geometry permits the emitted light signal to maintain integrity over a greater distance in air. Mirror block 94 is formed with four mirror faces 96a-96d which, according to the third preferred embodiment of the invention, are formed at respective angles of 45° to the axes of optical fibers 90a-90d. With this mirror configuration, a signal emitting from optical fiber lens 93a, when mirror block 94 is positioned between the optical fibers 90a-90d, follows path 98a to mirror face 96a, is reflected to mirror face 96b and further reflected to optical fiber lens 93b to enter optical fiber 90b. Thus the input and output optical fibers are positioned adjacent one another, rather than across from one another as described above. Since the spherical lenses 93a-93d permit a greater optical path length, the spacing is greater between the axes of fibers 90a and 90c and the axes of fibers 90b and 90d than in the earlier described embodiments. This spacing allows a flat portion 95 to be formed between the two symmetrical halves of mirror block 94, and a single force-applying member (not shown) to bear on flat 95. This configuration thus eliminates the need for dual, equal, force-applying members as shown in the first and second embodiments of the invention. As in the previously described embodiments, mirror platform 92 and mirror block 94 are deflected downward in a direction substantially perpendicular to the plane in which the axes of the optical fibers lie. The resiliency of the silicon of which the optical switch is formed, optionally increased by an auxiliary biasing member (not shown), returns optical platform 92 to its relaxed position in alignment with mirror chip 88, and mirror block 94 intercepts light signals 98a and 98b.

While the present invention is described with respect to specific embodiments thereof, it is recognized that various modifications and variations may be made without departing from the scope and spirit of the invention, which is more clearly and precisely defined by reference to the claims appended hereto.

What is claimed is:

1. An optical fiber and switch assembly, comprising:
(a) a planar member having linear guide means formed on a surface thereof;
(b) a pair of input optical fibers and a pair of output optical fibers mounted parallel to each other in the guide means;
(c) the input fibers and the output fibers being separated from one another so as to define a space therebetween; and
(d) a plurality of mirror faces arcuately moveable into and out of the space.

2. The optical fiber and switch assembly as claimed in claim 1, wherein the plurality of mirror faces resides on a resilient member that is fixedly connected to the planar member and deflectable to move the mirror faces from a first position for intersecting optical signals emitting from the input fibers and to a second position for not intersecting the optical signals.

3. The optical fiber and switch assembly as claimed in claim 2, wherein the resilient member is biased toward the first position.

4. The optical fiber and switch assembly as claimed in claim 3, wherein a supplementary biasing member is assembled adjacent the resilient member to further bias the resilient member toward the first position.

5. The optical fiber and switch assembly as claimed in claim 3, further comprising an actuator in contact with the resilient member for moving the mirror faces to the second position.

6. The optical fiber and switch assembly as claimed in claim 1, wherein the input optical fibers are oriented opposed to the output fibers.

7. The optical fiber and switch assembly as claimed in claim 1, wherein the input fibers are oriented parallel to the output fibers.

8. An optical switch, comprising:
(a) a rigid member having a planar surface and linear guiding means formed thereupon;
(b) a resilient member mounted to the rigid member and having a mirror face mounted thereon so as to be located substantially perpendicular to the planar surface; and
(c) wherein the resilient member is deflectable from a first position in which the mirror face is in the line of the linear guiding means to a second position in which the mirror face is out of the line of the linear guiding means.

9. The optical switch as described in claim 8, wherein the resilient member is integrally formed into a mirror chip and the mirror chip is fixedly mounted to the rigid member.

10. The optical switch as described in claim 8, wherein the guiding means is configured for locating a first pair of optical fibers parallel to one another and a second pair of optical fibers parallel to one another in an orientation so as to be juxtaposed to the first pair of optical fibers.

11. The optical switch as described in claim 9, wherein the mirror chip and the rigid member are each formed of crystalline material.

12. The optical switch as described in claim 11, wherein the crystalline material is silicon.

13. A method for making an optical switch, comprising the steps of:
(a) providing a rigid member having a planar surface;
(b) forming a linear support channel on the planar surface;
(c) providing a resilient member;
(d) forming a first pair of mirrors on and perpendicular to a surface of the resilient member in an orientation so as to reside at an angle to the linear support channel;
(e) forming a second pair of mirrors on and perpendicular to a surface of the resilient member in an orientation so as to reside at an angle to the linear support channel;
(f) mounting the resilient member to the rigid member so that the first pair of angularly positioned mirrors and the second pair of angularly positioned mirrors reside so that a beam of electromagnet energy emitting from a first optical fiber in the first support channel is diverted to a second optical fiber in the second support channel; and
(g) configuring the resilient member to move to a position wherein the first and second pair of angularly positioned mirrors do not affect a beam of electromagnetic energy emitting from the first optical fiber.

14. The method for making an optical switch as described in claim 13, further comprising the step of leaving a gap in the linear support channel so that the first and second optical fibers reside on opposite sides of the gap and the first and second pairs of mirrors move into and out of the gap between the first and second optical fibers.

15. The method for making an optical switch as described in claim 13, wherein the rigid member and the resilient member and the pairs of mirrors are formed of crystalline silicon.

16. The method for making an optical switch as described in claim 15, wherein the resilient member and the pairs of mirrors are formed integrally of a single piece of crystalline silicon.
